(19) United States
(12) Patent Application Publication
(10) Pub. No.: US 2013/0244104 A1
(43) Pub. Date: Sep. 19, 2013

(54) METHOD FOR PRODUCING NONAQUEOUS SECONDARY BATTERY ELECTRODE, NONAQUEOUS SECONDARY BATTERY, AND DRYING DEVICE

(71) Applicant: HITACHI, LTD., Tokyo (JP)

(72) Inventor: Tetsutaro INOUE, Ibaraki-shi (JP)

(73) Assignee: HITACHI, LTD., Tokyo (JP)

(21) Appl. No.: 13/793,780

(22) Filed: Mar. 11, 2013

(30) Foreign Application Priority Data
Mar. 15, 2012 (JP) 2012-058672
Dec. 17, 2012 (JP) 2012-274625

(51) Int. Cl. H01M 4/04; F26B 23/04; H01M 4/64

(52) U.S. Cl. CPC H01M 4/0404; H01M 4/64; F26B 23/04
USPC 429/211; 34/266; 427/557

(57) ABSTRACT

A method for producing a nonaqueous secondary battery electrode of the present invention includes: a coating formation step of applying an electrode mixture layer-forming composition containing an active material and a solvent onto a current collector so as to form a coating of the composition; an introducing step of introducing the current collector with the coating in a drying oven; and a drying step of drying the coating by irradiating the coating in the drying oven with near-infrared electromagnetic waves having a peak of a wavelength distribution in a range of 1 to 5 μm so as to form an electrode mixture layer. In the drying step, a temperature of the coating is set higher than a temperature in the drying oven by a range of 65° C. to 115° C.

### BACKGROUND OF THE INVENTION

1. Field of the Invention

The present invention relates to a method for producing a nonaqueous secondary battery electrode, a nonaqueous secondary battery, and a drying device.

2. Description of the Related Art

As electrodes (positive electrode and negative electrode) for nonaqueous secondary batteries such as lithium-ion secondary batteries, generally, electrodes having a structure in which an electrode mixture layer (positive electrode mixture layer and negative electrode mixture layer) containing an active material (positive electrode active material and negative electrode active material) is formed on one or both surfaces of a current collector are used. Such electrodes are produced by a method that includes: applying an electrode mixture layer-forming composition containing an active material and a solvent onto a current collector to form a coating; and subjecting the coating with a drying step to remove the solvent from the coating, thereby forming an electrode mixture layer, for example.

However, the above drying step may impair productivity of electrodes when the drying time is long, which accordingly impairs productivity of nonaqueous secondary batteries. Meanwhile, when the drying temperature is set high for shortening the drying time for example, quality of electrodes may be impaired, which may decrease characteristics of nonaqueous secondary batteries.

To cope with the above, various technologies have been studied for shortening the drying time of coatings under conditions sufficient to suppress quality loss of electrodes. For example, JP 4790092 A proposes a technology of enhancing drying efficiency of coatings by utilizing near-infrared electromagnetic waves having wavelengths suitable for cleaving hydrogen bonds that block vaporization of solvents. Further, JP 2010-255988A proposes a technology of enhancing drying efficiency of coatings by irradiating coatings with infrared rays and directly spraying the coatings with dry air.

However, although the productivity of nonaqueous secondary battery electrodes are enhanced by the above-mentioned technologies, there still is room for improvement in producing, with high productivity, electrodes that can enhance characteristics of nonaqueous secondary batteries further.

### SUMMARY OF THE INVENTION

The present invention was made in view of the forgoing circumstances, and its object is to provide a method for producing a nonaqueous secondary battery electrode capable of producing a nonaqueous secondary battery electrode having superior quality with high productivity, a nonaqueous secondary battery having superior battery characteristics, and a drying device suitable for producing a nonaqueous secondary battery electrode, which can improve quality and productivity of a nonaqueous secondary battery electrode.

In order to solve the above-described problems, a method for producing a nonaqueous secondary battery electrode of the present invention is a method for producing a nonaqueous secondary battery electrode in which an electrode mixture layer containing an active material is formed on one or both surfaces of a current collector, including: a coating formation step of applying an electrode mixture layer-forming composition containing the active material and a solvent onto the current collector so as to form a coating of the composition; an introducing step of introducing the current collector with the coating in a drying oven; and a drying step of drying the coating by irradiating the coating in the drying oven with near-infrared electromagnetic waves having a peak of a wavelength distribution in a range of 1 to 5 μm so as to form the electrode mixture layer. In the drying step, a temperature of the coating is set higher than a temperature in the drying oven by a range of 65° C. to 115° C.

According to the method for producing a nonaqueous secondary battery electrode of the present invention, it is possible to produce a nonaqueous secondary battery electrode having superior quality with high productivity.

Further, a nonaqueous secondary battery of the present invention includes: a positive electrode; a negative electrode; a nonaqueous electrolyte; and a separator, wherein at least one of the positive electrode and the negative electrode is a nonaqueous secondary battery electrode produced by the above-described method for producing a nonaqueous secondary battery electrode of the present invention.

By using the electrode produced by the method for producing a nonaqueous secondary battery electrode of the present invention, it is possible to provide a nonaqueous secondary battery having superior battery characteristics.

Further, a drying device of the present invention is used for production of a nonaqueous secondary battery electrode, and includes: a drying oven; a control portion that controls a temperature in the drying oven at 120° C. or lower; and an irradiation portion that irradiates an object to be dried in the drying oven with near-infrared electromagnetic waves having a peak of a wavelength distribution in a range of 1 to 5 μm. The control portion performs control so that a temperature of the object to be dried having been irradiated with the near-infrared electromagnetic waves is higher than the temperature in the drying oven by a range of 65° C. to 115° C.

According to the drying device of the present invention, it is possible to provide a drying device suitable for producing a nonaqueous secondary battery electrode, which can improve quality and productivity of a nonaqueous secondary battery electrode.

### BRIEF DESCRIPTION OF THE DRAWINGS

FIG. 1A is a cross-sectional view schematically showing an exemplary drying device of the present invention. FIGS. 1B and 1C are views for explaining discharging directions of gas from nozzles.

FIG. 2 is a cross-sectional view schematically showing another exemplary drying device of the present invention.

FIG. 3 is a schematic configuration view of a 90° Peeling Tester.

### DESCRIPTION OF THE PREFERRED EMBODIMENTS

(Method for Producing Nonaqueous Secondary Battery Electrode)

A method for producing a nonaqueous secondary battery electrode of the present invention is a method for producing a nonaqueous secondary battery electrode in which an electrode mixture layer containing an active material is formed on one or both surfaces of a current collector, including: a coating formation step of applying an electrode mixture layer-forming composition containing the active material and a solvent onto the current collector so as to form a coating of the composition; an introducing step of introducing the current collector with the coating in a drying oven; and a drying step of drying the coating by irradiating the coating in the drying oven with near-infrared electromagnetic waves having a peak of a wavelength distribution in a range of 1 to 5 μm so as to form the electrode mixture layer. In the drying step, a temperature of the coating is set higher than a temperature in the drying oven by a range of 65° C. to 115° C. Thus, it is possible to produce a nonaqueous secondary battery electrode having superior quality with high productivity.

The nonaqueous secondary battery electrode produced by the production method of the present invention is used as a positive electrode or a negative electrode of a nonaqueous secondary battery.

In the case where an electrode produced by the method for producing a nonaqueous secondary battery electrode of the present invention is a positive electrode, as the active material, i.e., a positive electrode active material, a layer-structured lithium-containing transition metal oxide represented by a general formula Li₁₊ₓM¹ₓO₂ (−0.1<x<0.1, Co, Ni, Mn, Al, Mg, Zr, Ti, etc.), an olivine-type compound represented by a general formula LiM2PO4 (M2: Co, Ni, Mn, Fe, etc.) and the like can be used, for example. Specific examples of the layer-structured lithium-containing transition metal oxide include LiCoO₂, LiNi_{1-y}Co_{y-z}Al_{z}O₂ (0.1≦y≦0.3, 0.01≦z≦0.2), and an oxide containing at least Co, Ni and Mn (such as LiMn_{1/3}Ni_{1/3}CO_{1/3}O₂, LiMn_{5/12}Ni_{5/12}Co_{1/6}O₂, LiNi_{3/5}Mn_{1/5}Co_{1/5}O₂, etc.). Further, examples of the positive electrode active material include: a spinel-structured lithium-containing composite oxide containing Mn, including a spinel manganese composite oxide typified by compositions such as LiMn₂O₄ and LiNi_{0.5}Mn_{1.5}O₄; a lithium-containing composite oxide having a spinel structure in which part of elements of the spinel manganese composite oxide is substituted with other elements such as Ca, Mg, Sr, Sc, Zr, V, Nb, W, Cr, Mo, Fe, Co, Ni, Zn, Al, Si, Ga, Ge and Sn, and a lithium-containing composite oxide represented by the general formula Li₁₊ₓM¹ₓO₂ or the general formula LiM²PO₄ that contains Mn as the element M¹ or M² and further contains one or more kinds of elements such as Ca, Mg, Sr, Sc, Zr, V, Nb, W, Cr, Mo, Fe, Co, Ni, Zn, Al, Si, Ga, Ge and Sn. For example, as the positive electrode active material, those exemplified above may be used alone or in combination of two or more kinds.

Further, when an electrode produced by the method for producing a nonaqueous secondary battery electrode of the present invention is a positive electrode, the electrode mixture layer, i.e., a positive electrode mixture layer preferably contains a conduction aid and a binder. Therefore, when a nonaqueous secondary battery positive electrode is produced by the method for producing a nonaqueous secondary battery electrode of the present invention, the electrode mixture layer-forming composition, i.e., a positive electrode mixture layer-forming composition preferably contains a conduction aid and a binder.

Examples of the conduction aid include: carbon blacks such as acetylene black, Ketjen black, channel black, furnace black, lamp black, and thermal black; conductive fibers such as carbon fiber and metallic fiber; carbon fluoride; metallic powders such as aluminum powder, copper powder, nickel powder; and organic conductive materials such as polyphenylene derivative. These may be used alone or in combination of two or more kinds.

Examples of the binder include polyvinylidene fluoride (PVDF), polytetrafluoroethylene (PTFE), styrene-butadiene rubber (SBR), carboxymethyl cellulose (CMC), polyvinyl pyrrolidone (PVP). These may be used alone or in combination of two or more kinds.

In the positive electrode mixture layer, the content of the positive electrode active material is preferably 60 to 95 mass %, the content of the conduction aid is preferably 3 to 20 mass %, and the content of the binder is preferably 1 to 15 mass %. Therefore, in the electrode mixture layer-forming composition, i.e., in the positive electrode mixture layer-forming composition used when a positive electrode is produced by the method for producing a nonaqueous secondary battery electrode of the present invention, the formed positive electrode mixture layer preferably contains the positive electrode active material, the conduction aid, and the binder in the above-described contents.

In the case where an electrode produced by the method for producing a nonaqueous secondary battery electrode of the present invention is a negative electrode, the following can be used as the active material, i.e., a negative electrode active material, for example: carbon materials, including graphite materials such as natural graphite (flake graphite), artificial graphite and expanded graphite; easily graphitizable carbonaceous materials such as cokes obtained by heating pitch; and hardly graphitizable carbonaceous materials such as furfuryl alcohol resin (FFA), polyparaphenylene (PPP), and amorphous carbon obtained by baking phenol resin at a low temperature. In addition to the carbon materials, lithium and lithium-containing compounds also can be used as the negative electrode active material. Examples of the lithium-containing compounds include lithium alloys such as Li—Al, and alloys containing an element such as Si and Sn that can be alloyed with lithium. Further, oxide-based materials such as Sn oxides and Si oxides also can be used.

Further, when an electrode produced by the method for producing a nonaqueous secondary battery electrode of the present invention is a negative electrode, the electrode mixture layer, i.e., a negative electrode mixture layer preferably contains a binder. Therefore, when a nonaqueous secondary battery negative electrode is produced by the method for producing a nonaqueous secondary battery electrode of the present invention, the electrode mixture layer-forming composition, i.e., a negative electrode mixture layer-forming composition preferably contains a binder. It is possible to use, as the binder of the negative electrode, various types of the binders exemplified above as binders that can be used when an electrode produced by the method for producing a nonaqueous secondary battery electrode of the present invention is a positive electrode.

Further, when an electrode produced by the method for producing a nonaqueous secondary battery electrode of the present invention is a negative electrode, the electrode mixture layer, i.e., the negative electrode mixture layer may contain a conduction aid as necessary. Therefore, when a nonaqueous secondary battery negative electrode is produced by the method for producing a nonaqueous secondary battery electrode of the present invention, the electrode mixture layer-forming composition, i.e., the negative electrode mixture layer-forming composition may contain a conduction aid as necessary. It is possible to use, as the conduction aid of the negative electrode, various types of the conduction aids exemplified above as conduction aids that can be used when an electrode produced by the method for producing a nonaqueous secondary battery electrode of the present invention is a positive electrode.

In the negative electrode mixture layer, the content of the negative electrode active material is preferably 80 to 99 mass %, and the content of the binder is preferably 1 to 20 mass %. Further, in the case of adding the conduction aid in the negative electrode mixture layer, the content of the conduction aid is preferably 1 to 10 mass %. Therefore, in the electrode mixture layer-forming composition, i.e., in the negative electrode mixture layer-forming composition used when a negative electrode is produced by the method for producing a nonaqueous secondary battery electrode of the present invention, the formed negative electrode mixture layer preferably contains the negative electrode active material, the binder, and as necessary, the conduction aid in the above-described contents.

A solvent is used in the electrode mixture layer-forming composition. Examples of the solvent include: organic solvents such as N-methyl-2-pyrrolidone (NMP), acetone and N,N-dimethylethyleneurea; and water. Among these, a solvent suitable for uniformly dissolving or dispersing the binder that is used in the electrode mixture layer-forming composition may be selected, for example.

A solid concentration of the electrode mixture layer-forming composition (total content of all the components excluding a solvent) is not limited as long as it is suitable for application to a current collector and can secure viscosity that permits an applied coating to maintain a certain thickness, for example. Specifically, the solid concentration is preferably 30 to 85 mass %.

In the coating formation step according to the method for producing a nonaqueous secondary battery electrode of the present invention, a coating is formed by applying the aforementioned electrode mixture layer-forming composition onto a current collector.

When an electrode produced by the method for producing a nonaqueous secondary battery electrode of the present invention is a positive electrode, the current collector, i.e., a positive electrode current collector may be, for example, a foil made of aluminum or an aluminum alloy, a perforated metal, a net, and an expanded metal. Generally, an aluminum foil or an aluminum alloy foil is used. The thickness of the positive electrode current collector is preferably 5 to 30 μm.

Further, when an electrode produced by the method for producing a nonaqueous secondary battery electrode of the present invention is a negative electrode, the current collector, i.e., a negative electrode current collector may be, for example, a foil made of copper or a copper alloy, a perforated metal, a net, and an expanded metal. Generally, a copper foil or a copper alloy foil is used. The thickness of the negative electrode current collector is preferably 5 to 30 μm.

The method for applying the electrode mixture layer-forming composition onto the current collector is not limited particularly, and conventionally-known various application methods can be adopted.

In the method for producing a nonaqueous secondary battery electrode of the present invention, after the coating formation step, a coating of the electrode mixture layer-forming composition that is formed on the current collector via the coating formation step is dried in a drying oven via an introducing step and a drying step. Thus, an electrode mixture layer is formed.

In the drying step, by irradiating the coating in the drying oven with near-infrared electromagnetic waves having a peak of a wavelength distribution in a range of 1 to 5 μm and increasing the temperature of the coating, the coating is dried.

The near-infrared electromagnetic waves having a peak of a wavelength distribution in a range of 1 to 5 μm are considered to exhibit superior abilities in cleaving hydrogen bonds. Irradiating the coating with such waves can cleave hydrogen bonds involving solvent molecules, whereby a solvent can be removed from the coating by vaporization efficiently. Therefore, in the drying step according to the method for producing a nonaqueous secondary battery electrode of the present invention, the drying time of the coating can be shortened, which enhances the productivity of nonaqueous secondary battery electrodes.

Further, in the drying step, it is sufficient if a difference between the temperature of the coating (coating formed of the electrode mixture layer-forming composition) heated higher than a temperature in the drying oven by irradiation with near-infrared electromagnetic waves and the temperature in the drying oven is in the range of 65° C. to 115° C. As long as the difference between the temperature in the drying oven and the temperature of the coating is in the above range, the quality of nonaqueous secondary battery electrodes to be produced is improved while inhibiting the drying time of the coating from being long. Thus, electrodes capable of configuring nonaqueous secondary batteries having further favorable battery characteristics can be produced.

In the drying step, if the difference between the temperature of the coating heated higher than the temperature in the drying oven by irradiation with near-infrared electromagnetic waves (hereinafter, referred to as the temperature of the coating during drying) and the temperature in the drying oven is too small, it becomes difficult to dry the coating, which requires a longer drying time. Meanwhile, in the drying step, when the difference between the temperature of the coating during drying and the temperature in the drying oven is too large, cohesion between the coating (electrode mixture layer) and the current collector decreases, which impairs the quality of nonaqueous secondary battery electrodes to be produced.

In the drying step, by controlling the temperature in the drying oven, the difference between the temperature of the coating during drying and the temperature in the drying oven can be controlled in the above value. The specific temperature in the drying oven during the drying step is preferably 120° C. or lower, more preferably 100° C. or lower, particularly preferably 70° C. or lower, and preferably 50° C. or more.

Further, by changing the configuration of the solvent in the coating, it is possible to adjust the difference between the temperature of the coating during drying and the temperature in the drying oven.

When the temperature in the drying oven is set at the above-mentioned value, it is difficult for conventional techniques (e.g., a drying method utilizing hot air) to vaporize and remove the solvent in the coating quickly. However, in the method for producing a nonaqueous secondary battery electrode of the present invention, since coatings are dried using near-infrared electromagnetic waves having a peak of a wavelength distribution in a range of 1 to 5 μm, they can be dried efficiently even when the inside of the drying oven is controlled at the above-mentioned low temperatures.

In the drying step, drying devices of the present invention mentioned below may be used.

A time during which the current collector with the coating of the electrode mixture layer-forming composition is introduced in the drying oven is preferably 140 seconds or less, and more preferably 70 seconds or less. By the method for producing a nonaqueous secondary battery electrode of the present invention, the coating can be dried favorably in such a short drying time.

In the drying step according to the method for producing a nonaqueous secondary battery electrode of the present invention, when the drying time is almost the same as those at the time of producing conventional nonaqueous secondary battery electrodes, quality of a produced nonaqueous secondary battery electrode can be more favorable than those of the conventional nonaqueous secondary battery electrodes. Further, in the drying step according to the method for producing a nonaqueous secondary battery electrode of the present invention, in the case of producing a nonaqueous secondary battery electrode having the quality equivalent to those of conventional nonaqueous secondary battery electrodes, the drying time can be shortened as compared with those of the conventional nonaqueous secondary battery electrodes.

The method for producing a nonaqueous secondary battery electrode of the present invention can be applied also to the case of using a long (sheet) current collector. Further, in this case, in the drying step, a drying device may be used that also includes a means for continuously transporting (Roll-to-Roll Coater, etc.) a long current collector with the coating of the electrode mixture layer-forming composition into the drying oven.

In general nonaqueous secondary battery electrodes, the electrode mixture layer is not formed on part of the current collector, and the part is left as an exposed portion. This exposed portion is used for electrical connection to another member of the nonaqueous secondary battery, or used for attachment of a lead for electrical connection to another member of the nonaqueous secondary battery. Therefore, in the case of continuously producing nonaqueous secondary battery electrodes by using a long current collector, generally, in the coating formation step, it is preferable to provide areas at predetermined intervals on the current collector where the electrode mixture layer-forming composition is not applied.

In the case of producing the nonaqueous secondary battery electrode having electrode mixture layers on both surfaces of the current collector, after forming one electrode mixture layer on one of the surfaces of the current collector via the coating formation step, the introducing step and the drying step, the other electrode mixture layer may be formed on the other surface of the current collector by performing the coating formation step, the introducing step and the drying step again.

After forming the electrode mixture layer on one or both surfaces of the current collector via the coating formation step, the introducing step and the drying step, pressing such as calendering may be performed as necessary so as to adjust the thickness and density of the electrode mixture layer. Further, as necessary, the resultant is cut into a required shape or size. Thus, nonaqueous secondary battery electrodes are obtained.

Further, in accordance with common procedures, leads for electrical connection to another member of the nonaqueous secondary battery can be attached to the nonaqueous secondary battery electrodes obtained via cutting, etc.

When the nonaqueous secondary battery electrode thus obtained is a positive electrode, the thickness of the positive electrode mixture layer is preferably 50 to 250 μm per one surface of the current collector, and the density thereof is preferably 2.0 to 5.0 g/cm³. Further, when the nonaqueous secondary battery electrode is a negative electrode, the thickness of the negative electrode mixture layer is preferably 40 to 230 μm per one surface of the current collector, and the density thereof is preferably 1.5 to 4.0 g/cm³. The density of the electrode mixture layer is calculated from a thickness and a mass per unit area of the electrode mixture layer laminated on the current collector.

(Nonaqueous Secondary Battery)

The nonaqueous secondary battery of the present invention is a nonaqueous secondary battery that includes a positive electrode, a negative electrode, a nonaqueous electrolyte, and a separator, wherein at least one of the positive electrode and the negative electrode is a nonaqueous secondary battery electrode produced by the method for producing a nonaqueous secondary battery electrode of the present invention. Thus, a nonaqueous secondary battery having superior battery characteristics can be obtained.

In the nonaqueous secondary battery of the present invention, it is sufficient if one of the positive electrode and the negative electrode is the nonaqueous secondary battery electrode produced by the method for producing a nonaqueous secondary battery electrode of the present invention. However, it is preferable that both of the positive electrode and the negative electrode are electrodes produced by the method for producing a nonaqueous secondary battery electrode of the present invention.

In the case of using the nonaqueous secondary battery electrode produced by the method for producing a nonaqueous secondary battery electrode of the present invention as one of the positive electrode and the negative electrode, the other electrode may be an electrode produced by the method for producing a nonaqueous secondary battery electrode having been adopted conventionally.

The nonaqueous secondary battery of the present invention is configured as follows, for example: preparing a laminated electrode assembly by laminating the above-mentioned positive electrode and the above-mentioned negative electrode via an after-mentioned separator, or preparing a wound electrode assembly by further winding the laminated electrode assembly spirally; and sealing the electrode assembly and an after-mentioned nonaqueous electrolyte in an outer case in accordance with common procedures.

The separator preferably has a property of closing its pores, i.e., a shutdown function, at 80° C. or more (more preferably 100° C. or more) and 170° C. or lower (more preferably 150° C. or lower). Further, as the separator, separators used in general nonaqueous secondary batteries such as lithium ion secondary batteries can be used. Examples of the separator include microporous films made of polyolefin such as polyethylene (PE) and polypropylene (PP). The microporous film constituting the separator may be formed solely of PE or PP, or a laminate body of a PE microporous film and a PP microporous film, for example. The thickness of the separator is preferably 10 to 30 μm, for example.

Further, on one or both surfaces of the above-mentioned microporous film made of polyolefin, a laminated-type separator formed of heat-resistant layers containing heat-resistant inorganic fillers such as silica, alumina and boehmite may be used.

Nonaqueous electrolytic solutions obtained by dissolving a lithium salt in the following organic solvents can be used as the nonaqueous electrolyte, for example.

Examples of the organic solvents include aprotic organic solvents such as ethylene carbonate (EC), propylene carbonate (PC), butylene carbonate (BC), dimethyl carbonate (DMC), diethyl carbonate (DEC), methyl ethyl carbonate (MEC), γ-butyrolactone (γ-BL), 1,2-dimethoxyethane (DME), tetrahydrofuran (THF), 2-methyltetrahydrofuran, dimethylsulfoxide (DMSO), 1,3-dioxolane, formamide, dimethylformamide (DMF), dioxolane, acetonitrile, nitromethane, methyl formate, methyl acetate, phosphate triester, trimethoxymethane, dioxolane derivatives, sulfolane, 3-methyl-2-oxazolidinone, propylene carbonate derivatives, tetrahydrofuran derivatives, diethyl ether, and 1,3-propanesultone. These may be used alone or in combination of two or more kinds.

Examples of the lithium salt include LiClO₄, LiPF₆, LiBF₄, LiAsF₆, LiSbF₆, LiCF₃SO₃, LiCF₃CO₂, Li₂C₂F₄ (SO₃)₂, LiN(CF₃SO₂)₂, LiC(CF₃SO₂)₃, LiCₙF₂ₙ₊₁SO₃ (2≦n≦7), and LiN(RfOSO₂)₂ (where Rf represents a fluoroalkyl group). These may be used alone or in combination of two or more kinds. The concentration of these lithium salts in the nonaqueous electrolytic solution is preferably 0.6 to 1.8 mol/L, and more preferably 0.9 to 1.6 mol/L.

Further, additives such as vinylene carbonates, 1,3-propanesultone, diphenyl disulfide, cyclohexyl benzene, biphenyl, fluorobenzene, and t-butyl benzene may be added to the nonaqueous electrolytic solution as needed for the purpose of enhancing characteristics such as safety, charge-discharge cycle characteristics and high temperature storage characteristics of batteries.

Further, a gel electrolyte obtained by adding a known gelling agent such as a polymer to the nonaqueous electrolytic solution can be used as the nonaqueous electrolyte.

The nonaqueous secondary battery of the present invention may be in the form of a cylinder (such as a rectangular cylinder and circular cylinder) whose outer case is made of a steel can or an aluminum can, etc. Moreover, the nonaqueous secondary battery may be a soft package battery whose outer case is a metal-evaporated laminated film.

The nonaqueous secondary battery of the present invention can be used in the same applications as those of conventionally known nonaqueous secondary batteries.

(Drying Device)

A drying device of the present invention is a drying device used for production of a nonaqueous secondary battery electrode, and includes a drying oven, a control portion that controls a temperature in the drying oven at 120° C. or lower, and an irradiation portion that irradiates an object to be dried in the drying oven with near-infrared electromagnetic waves having a peak of a wavelength distribution in a range of 1 to 5 μm. The control portion performs control so that a temperature of the object to be dried having been irradiated with the near-infrared electromagnetic waves is higher than the temperature in the drying oven by a range of 65° C. to 115° C. Thus, it is possible to provide a drying device suitable for producing a nonaqueous secondary battery electrode, which can improve the quality and productivity of a nonaqueous secondary battery electrode.

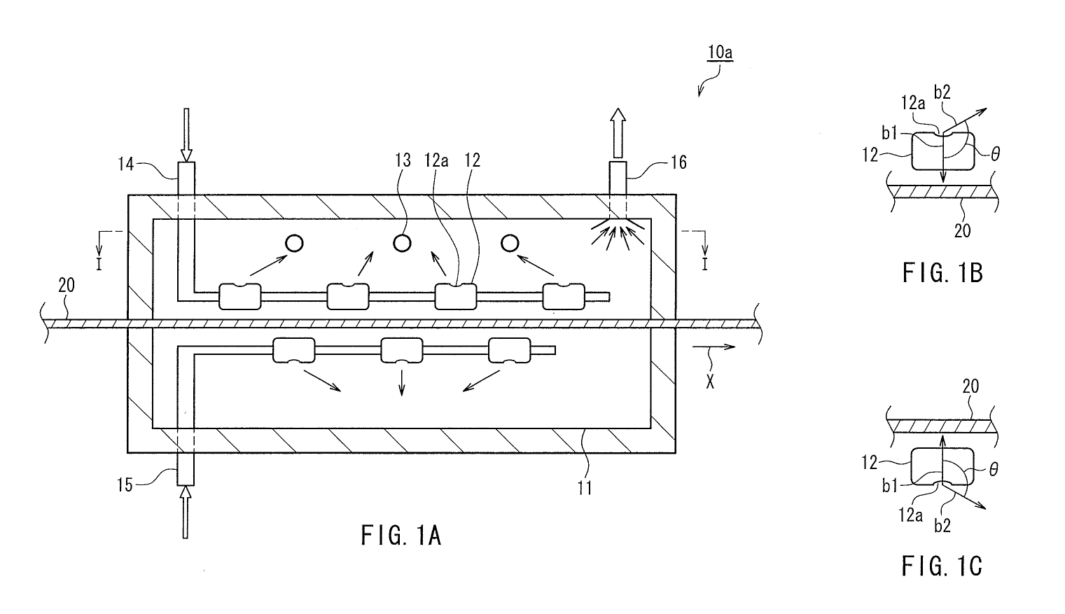

FIG. 1A is a cross-sectional view schematically showing an exemplary drying device of the present invention. A drying device 10a shown in FIG. 1A includes a drying oven 11, a plurality of irradiation portions 13, and a control portion that includes nozzles 12, inlets 14, 15, an outlet 16 and a temperature adjuster (not shown). An object to be dried 20 is dried in the drying oven 11. FIG. 1A shows a state in which a long (sheet) current collector whose principal surface is coated with an electrode mixture layer-forming composition is used as the object to be dried 20, and the sheet current collector is transported in an arrow direction (transport direction) X so as to be dried in the drying oven 11.

The drying oven 11 is in a box shape with an internal space. In both end walls in the longitudinal direction of the drying oven 11 (the left and right side surfaces in FIG. 1A), openings (not shown) are formed for allowing passage of the object to be dried 20. The object to be dried 20 having been transported along the transport direction X is introduced in the drying oven 11 via one of the opening, and discharged to the outside of the drying oven 11 from the other opening.

By irradiating a surface to be dried of the object to be dried 20 with near-infrared electromagnetic waves, the irradiation portions 13 raise the temperature of the object to be dried 20 to a specified temperature and vaporize liquids from the object to be dried 20 quickly. Each irradiation portion 13 is formed in an elongated shape, and its longitudinal direction is oriented to the orthogonal direction of the transport direction X. In other words, the irradiation portions 13 are provided across the full width of the sheet object to be dried 20, thereby irradiating the full width of the sheet object to be dried 20 with near-infrared electromagnetic waves. In FIG. 1A, a plurality of the irradiation portions 13 (here, three) are arranged in series along the transport direction X of the object to be dried 20.

An example of the irradiation portion 13 is an infrared heater having a plurality of tubes whose filaments for emitting infrared electromagnetic waves are covered with a filter. The filter transmits near-infrared electromagnetic waves having a peak of a wavelength distribution at any point in a range of 1 to 5 μm and absorbs electromagnetic waves having a peak of a wavelength distribution in the other wavelength regions. Further, in the infrared heater, it is preferable to provide channels for flowing cooling fluid between the plurality of tubes, so as to suppress unnecessary temperature rise due to the infrared heater. An example of such an infrared heater is a heater described in JP 4790092 A above.

The control portion controls the temperature in the drying oven 11 preferably at 120° C. or lower, more preferably at 100° C. or lower, particularly preferably at 70° C. or lower, and more preferably at 50° C. or more. In FIG. 1A, the control portion includes: the inlets 14, 15 that suction gas (air) outside the drying oven 11; the plurality of nozzles 12 that discharge gas suctioned at the inlets 14, 15 into the drying oven 11; the outlet 16 that discharges gas in the drying oven 11 to the outside of the drying oven 11; and the temperature adjuster (not shown) that adjusts a temperature of gas suctioned at the inlets 14, 15. An example of the temperature adjuster is a heater attached to piping of the inlets 14, 15. Other than this, the temperature adjuster may be one that circulates gas in the drying oven 11 by mechanically or electrically controlling ON/OFF of the inlets 14, 15 and the outlet 16 in accordance with the temperature in the drying oven 11 and that controls the temperature in the drying oven 11. Thus, since the temperature in the drying oven can be controlled within a certain range, it is possible to continuously produce nonaqueous secondary battery electrodes having superior quality, which can enhance the productivity of nonaqueous secondary batteries.

The inlet 14 is formed in a top surface (an upper surface in FIG. 1A) of the drying oven 11 and on an uppermost stream side of the transport direction X of the object to be dried 20. The inlet 15 is formed in a bottom surface (a lower surface in FIG. 1A) of the drying oven 11 and on the uppermost stream side of the transport direction X of the object to be dried 20. The outlet 16 is formed in the top surface of the drying oven 11 and on a lowermost stream side of the transport direction X of the object to be dried 20. Generally one outlet is formed on the drying oven 11, but a plurality of outlets may be formed on the drying oven 11. Further, it is sufficient to form at least one inlet on the drying oven 11, but a plurality of inlets may be formed on the drying oven 11 for increasing flexibility in arranging nozzles. Further, the outlet and the inlet are preferably arranged such that one of them is disposed at an upstream edge and the other is disposed at a downstream edge so that a gas flow in the entire drying oven 11 can be controlled, for example. As shown in FIG. 1A, the plurality of nozzles 12 are arranged in series along the transport direction X of the object to be dried 20. Further, each nozzle 12 has a vent 12a for discharging gas.

The temperature adjuster (not shown) includes a heating device (not shown) composed of heaters such as an electric heater and an oil heater and a cooling device (not shown) that utilizes refrigerants (ambient air, water, etc.), and adjusts the temperature of gas introduced in the drying oven 11. The heating device and the cooling device are disposed outside the drying oven 11.

The gas discharged from the vent 12a of the nozzle 12 is set so as not to contact the object to be dried 20 directly. Here, discharging directions of gas from the vent 12a of the nozzle 12 will be explained using FIGS. 1B and 1C. FIG. 1B is a view for explaining the discharging direction of gas from the nozzle 12 connected to the inlet 14, and FIG. 1C is a view for explaining the discharging direction of gas from the nozzle 12 connected to the inlet 15. In FIGS. 1B and 1C, an arrow b1 indicates a direction perpendicular to the object to be dried 20 from the vent 12a of the nozzle 12, an arrow b2 indicates the discharging direction of gas from the vent 12a, and an angle θ indicates an angle between the direction b1 perpendicular to the object to be dried 20 from the nozzle 12 and the discharging direction b2 of gas from the nozzle 12. In the present invention, the discharging direction of gas from the nozzle 12, i.e., the above-mentioned angle θ is set to be 90 to 270 degrees when the direction b1 perpendicular to the object to be dried 20 from the nozzle 12 is assumed to be 0 degree. Thus, the gas discharged from the vent 12a of the nozzle 12 is used only for circulating gas in the drying oven 11 without contacting the object to be dried 20 directly. Further, since the gas does not contact the object to be dried 20 directly, it is possible to control a vapor rate.

The drying device of the present invention may include either one drying oven 11 as shown in FIG. 1A, or a plurality of drying ovens 11(two, three, four, etc.).

Hereinafter, the present invention will be described in detail based on Examples. It should be noted, however, that the Examples discussed below are not intended to limit the present invention.

### Example 1

A negative electrode mixture layer-forming composition (a negative electrode mixture layer-forming slurry) was prepared by mixing, with an appropriate amount of water as a solvent, 48 parts by mass of natural graphite and 48 parts by mass of artificial graphite as negative electrode active materials and 2.0 parts by mass of CMC and 2.0 parts by mass of SBR as binders. The negative electrode mixture layer-forming slurry was applied to one surface of a 7 μm-thick sheet current collector made of a copper foil so that exposed portions of the current collector were left. Thus, a coating of the negative electrode mixture layer-forming slurry was formed.

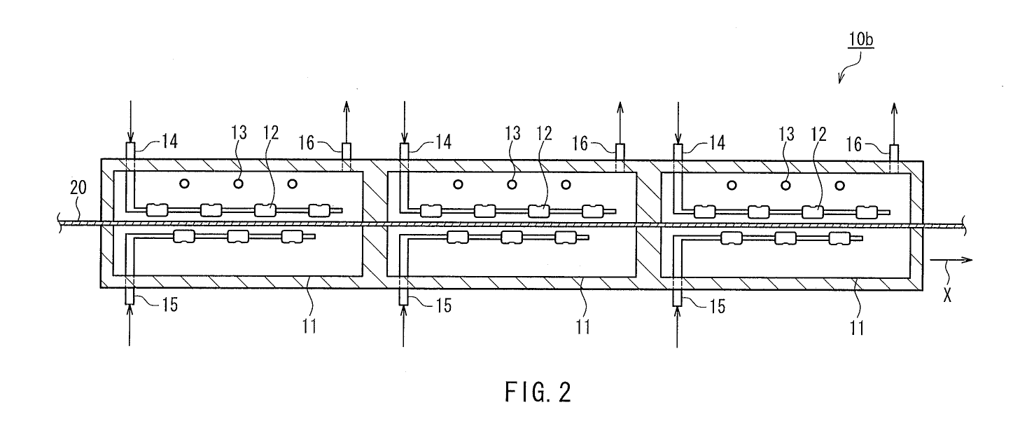

A drying device was used to dry the sheet current collector with the coating of the negative electrode mixture layer-forming slurry, i.e., the object to be dried 20, thereby forming a 100 μm-thick negative electrode mixture layer. Here, a cross-sectional view schematically showing a cross section of the drying device used in the present Examples is illustrated in FIG. 2. In FIG. 2, the same constituent elements as those in FIG. 1A are denoted with the same reference numerals, and detailed explanations thereof will be omitted.

A drying device 10b shown in FIG. 2 has three drying ovens 11, each of which has three irradiation portions 13. Here, as the irradiation portions 13, infrared heaters are used that can irradiate the object to be dried 20 with near-infrared electromagnetic waves having a peak of a wavelength distribution in a range of 1 to 5 μm. Further, in the drying device 10b, gas whose temperature has been adjusted by a temperature adjuster (not shown) is introduced in the drying oven 11 via the inlets 14, and the nozzles 12, and discharged to the outside of the drying oven 11 from the outlets 16. Thus, the gas in the drying oven 11 is circulated, and the temperature in the drying oven 11 is controlled at a desired value. Black arrows in FIG. 2 indicate a distribution direction of gas (air).

The sheet current collector with the coating (in FIG. 2, the coating and the current collector are not illustrated distinguishably from each other), i.e., the object to be dried 20 is introduced in the drying oven 11 with the coating formation surface facing the irradiation portion 13 side, transported to the arrow direction X in FIG. 2, and introduced in the drying oven 11 positioned at the left end of the drying device 10b in FIG. 2, the drying oven 11 in the center and the drying oven 11 at the right end in this order, thereby being dried.

In the present Example 1, while controlling the temperature in the drying oven 11 at a specified temperature by circulating gas in the drying oven 11 by means of the control portion, outputs of the infrared heaters that are the irradiation portions 13 were adjusted at 120 W and the coating was irradiated with near-infrared electromagnetic waves having a peak of a wavelength distribution in a range of 1 to 5 μm so that the temperature of the coating was increased to be higher than the temperature in the drying oven. Thus, the coating was dried. In the present Example 1, an initial temperature in the drying oven 11 was set at 30° C. The temperature in the drying oven 11 after a lapse of 20 minutes was also 30° C. This shows that the control portion controlled the temperature in the drying oven 11 in Example 1 at 30° C. Further, the temperature of the coating in the present Example 1 (i.e., the temperature of the coating after temperature rise by irradiation of near-infrared electromagnetic waves; hereinafter, referred to as the temperature of the coating during drying) was 101° C., and the difference between the temperature of the coating during drying and the temperature in the drying oven was 71° C. Incidentally, the temperature of the coating increases directly after irradiation of near-infrared electromagnetic waves using infrared heaters. Therefore, the temperature of the coating was measured directly after the irradiation using the infrared heaters.

At the time of drying, several kinds of current collectors (samples) with coatings formed under the same conditions were prepared, and masses of the current collectors with coatings taken out from the drying oven per specified time from the beginning of drying were measured. A time when a difference in mass between a present sample and a sample taken out one second before the present sample became 0.05 g/(100 cm²) was defined as a completion time of the drying of the coating (hereinafter; referred to as “drying time”. The “drying time” corresponds to a time during which the current collector with the coating is introduced in the drying oven 11). The drying time of the coating in Example 1 was 138 seconds.

### Example 2

A negative electrode was produced in the same manner as in Example 1, except that the output of the infrared heater at the time of drying was changed to 360 W. In the present Example 2, the temperature of the coating during drying was 142° C., and the difference between the temperature of the coating during drying and the temperature in the drying oven was 112° C. Further, the drying time of the coating was 81 seconds.

### Example 3

A negative electrode was produced in the same manner as in Example 1, except that the control temperature in the drying oven was changed to 60° C. In the present Example 3, the temperature of the coating during drying was 129° C., and the difference between the temperature of the coating during drying and the temperature in the drying oven was 69° C. Further, the drying time of the coating was 118 seconds.

### Example 4

A negative electrode was produced in the same manner as in Example 1, except that the output of the infrared heater at the time of drying was changed to 360 W, and the control temperature in the drying oven was changed to 60° C. In the present Example 4, the temperature of the coating during drying was 170° C., and the difference between the temperature of the coating during drying and the temperature in the drying oven was 110° C. Further, the drying time of the coating was 61 seconds.

### Example 5

A negative electrode was produced in the same manner as in Example 1, except that the control temperature in the drying oven was changed to 90° C. In the present Example 5, the temperature of the coating during drying was 161° C., and the difference between the temperature of the coating during drying and the temperature in the drying oven was 71° C. Further, the drying time of the coating was 105 seconds.

### Example 6

A negative electrode was produced in the same manner as in Example 1, except that the output of the infrared heater at the time of drying was changed to 360 W, and the control temperature in the drying oven was changed to 90° C. In the present Example 6, the temperature of the coating during drying was 199° C., and the difference between the temperature of the coating during drying and the temperature in the drying oven was 109° C. Further, the drying time of the coating was 44 seconds.

### Example 7

A negative electrode was produced in the same manner as in Example 1, except that the control temperature in the drying oven was changed to 120° C. In the present Example 7, the temperature of the coating during drying was 190° C., and the difference between the temperature of the coating during drying and the temperature in the drying oven was 70° C. Further, the drying time of the coating was 91 seconds.

### Example 8

A negative electrode was produced in the same manner as in Example 1, except that the output of the infrared heater at the time of drying was changed to 360 W, and the control temperature in the drying oven was changed to 120° C. In the present Example 8, the temperature of the coating during drying was 230° C., and the difference between the temperature of the coating during drying and the temperature in the drying oven was 110° C. Further, the drying time of the coating was 32 seconds.

### Comparative Example 1

A negative electrode was produced in the same manner as in Example 1, except that the output of the infrared heater at the time of drying was changed to 100 W. In the present Comparative Example 1, the temperature of the coating during drying was 91° C., and the difference between the temperature of the coating during drying and the temperature in the drying oven was 61° C. Further, the drying time of the coating was 182 seconds.

### Comparative Example 2

A negative electrode was produced in the same manner as in Example 1, except that the output of the infrared heater at the time of drying was changed to 385 W. In the present Comparative Example 2, the temperature of the coating during drying was 148° C., and the difference between the temperature of the coating during drying and the temperature in the drying oven was 118° C. Further, the drying time of the coating was 76 seconds.

### Comparative Example 3

A negative electrode was produced in the same manner as in Example 1, except that the output of the infrared heater at the time of drying was changed to 100 W, and the control temperature in the drying oven was changed to 120° C. In the present Comparative Example 3, the temperature of the coating during drying was 182° C., and the difference between the temperature of the coating during drying and the temperature in the drying oven was 62° C. Further, the drying time of the coating was 141 seconds.

### Comparative Example 4

A negative electrode was produced in the same manner as in Example 1, except that the output of the infrared heater at the time of drying was changed to 385 W, and the control temperature in the drying oven was changed to 120° C. In the present Comparative Example 4, the temperature of the coating during drying was 239° C., and the difference between the temperature of the coating during drying and the temperature in the drying oven was 119° C. Further, the drying time of the coating was 25 seconds.

### Comparative Example 5

A negative electrode was produced in the same manner as in Example 1, except that a hot-air drying machine was used in place of the drying device, and the control temperature in the drying machine was set at 90° C. for drying the coating. In the present Comparative Example 5, the temperature of the coating during drying was 90° C., and the difference between the temperature of the coating during drying and the temperature in the drying oven was 0° C. Further, the drying time of the coating was 181 seconds.

### Comparative Example 6

A negative electrode was produced in the same manner as in Comparative Example 5, except that the temperature in the hot-air drying machine was changed to 120° C. for drying the coating. In the present Comparative Example 6, the temperature of the coating during drying was 121° C., and the difference between the temperature of the coating during drying and the temperature in the drying oven was 1° C. Further, the drying time of the coating was 140 seconds.

### Comparative Example 7

A negative electrode was produced in the same manner as in Example 5, except that the temperature control in the drying oven was not performed. In the present Comparative Example 7, the temperature in the drying oven after a lapse of 20 minutes was 140° C. Further, the temperature of the coating during drying was 161° C., and the drying time of the coating was 105 seconds.

### Comparative Example 8

A negative electrode was produced in the same manner as in Example 6, except that the temperature control in the drying oven was not performed. In the present Comparative Example 8, the temperature in the drying oven after a lapse of 20 minutes was 140° C. Further, the temperature of the coating during drying was 199° C., and the drying time of the coating was 44 seconds.

### Comparative Example 9

A negative electrode was produced in the same manner as in Example 7, except that the temperature control in the drying oven was not performed. In the present Comparative Example 9, the temperature in the drying oven after a lapse of 20 minutes was 150° C. Further, the temperature of the coating during drying was 190° C., and the drying time of the coating was 91 seconds.

### Comparative Example 10

A negative electrode was produced in the same manner as in Example 8, except that the temperature control in the drying oven was not performed. In the present Comparative Example 10, the temperature in the drying oven after a lapse of 20 minutes was 160° C. Further, the temperature of the coating during drying was 230° C., and the drying time of the coating was 32 seconds.

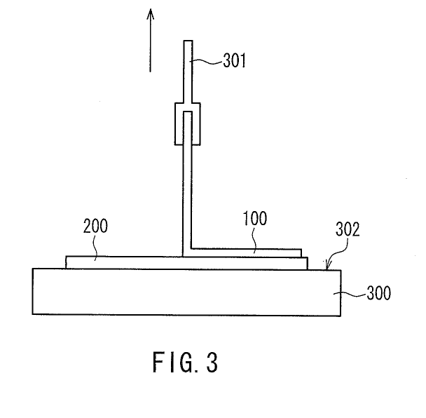

Regarding the negative electrodes according to the above Examples 1-8 and Comparative Examples 1-10, the following peel-strength measurement was conducted using a 90° Peeling Tester “TE-3001” produced by TESTER SANGYO Co., Ltd. A schematic configuration of the 90° Peeling Tester is shown in FIG. 3. The 90° Peeling Tester includes: an installation stage 300 having a sample installation surface 302; a double-sided tape 200 for adhering a sample 100 to the sample installation surface 302; and a jug 301 for peeling the sample 100 adhered to the sample installation surface 302. The peel-strength measurement was conducted in the following manner. First, the negative electrodes obtained in the above Examples and Comparative Examples (i.e., the current collectors having negative electrode mixture layers) were cut into 10 cm in a longitudinal direction and 1 cm in a width direction to form samples 100. One surface of the double-sided tape 200 (“NICE TACK NW-15” produced by NICHIBAN Co., Ltd.) was adhered to an end portion of the sample 100, and the other surface of the double-sided tape was adhered to the sample installation surface 302 as shown in FIG. 3. Then, an end portion of the sample 100 on the side opposite to the side adhered to the sample installation surface 302 was pinched by the jug 301, and pulled in the longitudinal direction (arrow direction in FIG. 3) at an angle of 90° with respect to the sample installation surface 302 at a peel rate of 50 mm/min, so as to peel the negative electrode mixture layer and the current collector. The strength at that time was measured. It can be judged that the larger the measured value of the peel strength, the better the quality of the electrode (negative electrode). Here, the quality of the electrode was judged as inferior if the peel strength was 3.0 gf/cm or less.

Tables 1 and 2 show conditions (the output of infrared heater, the initial temperature in the drying oven, the temperature in the drying oven after a lapse of 20 minutes, the presence or absence of hot air directly contacting the coating, the temperature of the coating during drying, the difference between the temperature of the coating during drying and the temperature in the drying oven, and the drying time) at the time of producing the negative electrodes according to the above-described Examples 1-8 and Comparative Examples 1-10 and the measurement results of the above-described peel-strength measurement.

TABLE 1

| | Ex 1 | Ex 2 | Ex 3 | Ex 4 | Ex 5 | Ex 6 | Ex 7 | Ex 8 |
|---|---|---|---|---|---|---|---|---|
| Output of infrared heater (W) | 120 | 360 | 120 | 360 | 120 | 360 | 120 | 360 |
| Initial temperature in drying oven (° C.) | 30 | 30 | 60 | 60 | 90 | 90 | 120 | 120 |
| Temperature in drying oven after lapse of | 30 | 30 | 60 | 60 | 90 | 90 | 120 | 120 |
| 20 minutes (° C.) | | | | | | | | |
| Presence or absence of hot air directly | No | No | No | No | No | No | No | No |
| contacting coating | | | | | | | | |
| Temperature of coating (° C.) | 101 | 142 | 129 | 170 | 161 | 199 | 190 | 230 |
| Difference between temperature of coating | 71 | 112 | 69 | 110 | 71 | 109 | 70 | 110 |
| and temperature in drying oven (° C.) | | | | | | | | |
| Drying time (seconds) | 138 | 81 | 118 | 61 | 105 | 44 | 91 | 32 |
| Peel strength (gf/cm) | 10.1 | 5.0 | 9.5 | 4.6 | 9.1 | 4.3 | 6.5 | 3.4 |

TABLE 2

| | Com. | Com. | Com. | Com. | Com. | Com. | Com. | Com. | Com. | Com. |
|---|---|---|---|---|---|---|---|---|---|---|
| | Ex 1 | Ex 2 | Ex 3 | Ex 4 | Ex 5 | Ex 6 | Ex 7 | Ex 8 | Ex 9 | Ex 10 |
| Output of infrared heater (W) | 100 | 385 | 100 | 385 | No | No | 120 | 360 | 120 | 360 |
| Initial temperature in drying oven (° C.) | 30 | 30 | 120 | 120 | 90 | 120 | 90 | 90 | 120 | 120 |
| Temperature in drying oven after lapse of | 30 | 30 | 120 | 120 | 90 | 120 | 140 | 140 | 150 | 160 |
| 20 minutes (° C.) | | | | | | | | | | |
| Presence or absence of hot air directly | No | No | No | No | Yes | Yes | No | No | No | No |
| contacting coating | | | | | | | | | | |
| Temperature of coating (° C.) | 91 | 148 | 182 | 239 | 90 | 121 | 161 | 199 | 190 | 230 |
| Difference between temperature of coating | 61 | 118 | 62 | 119 | 0 | 1 | 21 | 59 | 40 | 70 |
| and temperature in drying oven (° C.) | | | | | | | | | | |
| Drying time (seconds) | 182 | 76 | 141 | 25 | 181 | 140 | 105 | 44 | 91 | 32 |
| Peel strength (gf/cm) | 10.4 | 2.8 | 6.5 | 1.0 | 7.4 | 3.0 | 1.1 | 0.8 | 0.8 | 0.5 |

As shown in Tables 1 and 2, regarding the negative electrodes according to Examples 1-8 that were produced, at the time of drying the coating formed of the negative electrode mixture layer-forming slurry, by irradiating the coating with near-infrared electromagnetic waves having a peak of a wavelength distribution in a range of 1 to 5 μm and controlling the temperature in the drying oven so as to properly adjust the difference between the temperature of the coating and the temperature in the drying oven, the peel strength between the negative electrode mixture layer and the current collector was high and the quality was favorable. Further, the drying of the coating was completed in short drying time, and hence the productivity was favorable. Therefore, by using the negative electrodes according to Examples 1-8, it becomes possible to produce nonaqueous secondary batteries having favorable battery characteristics with high productivity.

On the other hand, in Comparative Examples 1 and 3 where the difference between the temperature of the coating and the temperature in the drying oven was too small at the time of drying the coating formed of the negative electrode mixture layer-forming slurry, the drying time of the coating was long, and the productivity of the negative electrode was inferior. Further, in Comparative Examples 2 and 4 where the difference between the temperature of the coating and the temperature in the drying oven was too large at the time of drying the coating formed of the negative electrode mixture layer-forming slurry, the peel strength between the negative electrode mixture layer and the current collector was low, and the quality of the negative electrode was inferior. Comparative Examples 5 and 6 are examples where the coating formed of the negative electrode mixture layer-forming slurry was dried by hot air in the same manner as in the conventional method. Between these examples, in Comparative Example 5 where the drying temperature (temperature of hot air) was set low, the drying time of the coating was long and the productivity of the negative electrode was inferior, whereas in Comparative Example 6 where the drying temperature (temperature of hot air) was set high, the peel strength between the negative electrode mixture layer and the current collector was low and the quality of the negative electrode was inferior. In Comparative Examples 7-10 where the temperature control in the drying oven was not performed, the peel strength between the negative electrode mixture layer and the current collector was extremely low, and the quality of the negative electrode was inferior.

According to the present invention, it is possible to provide a method for producing a nonaqueous secondary battery electrode capable of producing a nonaqueous secondary battery electrode having superior quality with high productivity, a method for producing a nonaqueous secondary battery capable of producing a nonaqueous secondary battery having superior battery characteristics with high productivity, and a drying device suitable for producing a nonaqueous secondary battery electrode, which can improve quality and productivity of a nonaqueous secondary battery electrode.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method for producing a nonaqueous secondary battery electrode in which an electrode mixture layer containing an active material is formed on one or both surfaces of a current collector, comprising:
a coating formation step of applying an electrode mixture layer-forming composition containing the active material and a solvent onto the current collector so as to form a coating of the composition;
an introducing step of introducing the current collector with the coating in a drying oven; and
a drying step of drying the coating by irradiating the coating in the drying oven with near-infrared electromagnetic waves having a peak of a wavelength distribution in a range of 1 to 5 μm so as to form the electrode mixture layer,
wherein, in the drying step, a temperature of the coating is set higher than a temperature in the drying oven by a range of 65° C. to 115° C.

2. The method for producing a nonaqueous secondary battery electrode according to claim 1, wherein the temperature in the drying oven is controlled at 120° C. or lower.

3. The method for producing a nonaqueous secondary battery electrode according to claim 1, wherein a time during which the current collector with the coating is introduced in the drying oven is 140 seconds or less.

4. A nonaqueous secondary battery, comprising:
a positive electrode;
a negative electrode;
a nonaqueous electrolyte; and
a separator,
wherein at least one of the positive electrode and the negative electrode is a nonaqueous secondary battery electrode produced by the method for producing a nonaqueous secondary battery electrode according to claim 1.

5. A drying device used for production of a nonaqueous secondary battery electrode, comprising:
a drying oven;
a control portion that controls a temperature in the drying oven at 120° C. or lower; and
an irradiation portion that irradiates an object to be dried in the drying oven with near-infrared electromagnetic waves having a peak of a wavelength distribution in a range of 1 to 5 μm,
wherein the control portion performs control so that a temperature of the object to be dried having been irradiated with the near-infrared electromagnetic waves is higher than the temperature in the drying oven by a range of 65° C. to 115° C.

6. The drying device according to claim 5,
wherein the control portion includes an inlet that suctions gas outside the drying oven, a nozzle that discharges gas suctioned at the inlet into the drying oven, an outlet that discharges gas in the drying oven to the outside of the drying oven, and a temperature adjuster that adjusts a temperature of gas suctioned at the inlet, and
the control portion controls the temperature in the drying oven by circulating gas in the drying oven.

7. The drying device according to claim 6, wherein a discharging direction of gas from the nozzle is set so as to form an angle of 90 to 270 degrees when a direction perpendicular to the object to be dried from the nozzle is assumed to be 0 degree.
